(19) United States
(12) Patent Application Publication
(10) Pub. No.: US 2020/0119461 A1
(43) Pub. Date: Apr. 16, 2020

(54) DUAL BAND ANTENNA FOR 4G/5G WIRELESS COMMUNICATIONS AND DEFECTED CENTER COAXIAL FILTER

(71) Applicant: Amphenol Antenna Solutions, Inc., Rockford, IL (US)

(72) Inventors: Joshua Wayne SHEHAN, Melbourne, FL (US); Ryan Seamus ADAMS, Grand Forks, ND (US)

(21) Appl. No.: 16/594,485

(22) Filed: Oct. 7, 2019

Related U.S. Application Data
(60) Provisional application No. 62/743,882, filed on Oct. 10, 2018.

(51) Int. Cl. H01Q 21/30; H01Q 5/47; H01Q 21/06; H01P 1/213

(52) U.S. Cl. CPC H01Q 21/30; H01P 1/2133; H01Q 21/065; H01Q 5/47

(57) ABSTRACT

A dual band microwave/millimeter wave antenna for next generation wireless systems. The antenna assembly has a low frequency monopole antenna and a sleeve with high frequency antenna arrays. A three-sided sleeve monopole antenna provides omnidirectional radiation patterns from ˜1.7-2.7 GHz, and each side of the sleeve monopole incorporates two series-fed linear patch arrays operating at ˜27.5-28.35 GHz. The sleeve monopole provides 3G/4G/LTE coverage while the patch arrays provide sectored MIMO 5G coverage.

### RELATED APPLICATIONS

This application claims the benefit of U.S. Provisional Application No. 62/743,882, filed Oct. 10, 2018, the entire contents of which are incorporated herein by reference.

### BACKGROUND OF THE DISCLOSURE

### Field of the Disclosure

The present disclosure generally relates to antennas, and more specifically to dual band antennas for next generation mobile wireless applications.

### BACKGROUND OF THE RELATED ART

Fifth generation (5G) communications systems promise to significantly enhance mobile communications systems with multi gigabit-per-second (Gbps) data rates and nearly ubiquitous coverage. One of the keys to 5G is the use of millimeter wave spectrum where a large amount of spectrum is available for use that can provide the bandwidth to enable the desired data rates. One of the challenges is ensuring that 5G systems integrate seamlessly with technology from older generations (3G, 4G, etc.) since there will be a period of overlap where 5G is being deployed, but older systems are still in operation.

An additional challenge is ensuring strong enough signals to supply the desired data rates at high frequencies where path loss is problematic. For example, the path loss at a distance of 1 mile at 2.5 GHz for an isotropic radiator is ˜104.5 dB. This means that if a transmitter with an isotropic radiator sends 1 W of power at 2.5 GHz, the power level would be ˜35.2 pW by the time it reached a distance of 1 mile. On the other hand, the path loss at a distance of 1 mile at 28 GHz for an isotropic radiator is ˜125.5 dB. This means that if a transmitter with an isotropic radiator sends 1 W of power at 28 GHz, the power level would only be ˜0.28 pW by the time it reached a distance of 1 mile. Because of this, antenna arrays are of interest at or near millimeter wave where the array can provide high antenna gain to overcome the associated path loss. If the antenna gain at the transmitter is increased to 10 dBi, the path loss is improved to ˜115.5 dBi corresponding to a power level of ˜2.8 pW at a distance of 1 mile.

This leads to a need for antennas that operate at microwave frequencies for older generation technology as well as at (or near) millimeter wave frequencies for 5G systems. Additionally, the higher frequencies may require antenna arrays in order to provide the power levels to enable the desired data rates.

### SUMMARY OF THE DISCLOSURE

The present disclosure details a dual band antenna covering microwave and millimeter wave frequencies for next generation mobile wireless applications. The antenna is comprised of a three-sided sleeve monopole antenna that provides omnidirectional coverage from ˜1.7-2.7 GHz for 3G/4G/LTE coverage, and each side of the sleeve incorporates two series-fed patch arrays operating from ˜27.5-28.35 GHz for sectored MIMO 5G coverage. Each patch array is comprised of a three-element series-fed array providing approximately 10 dBi of gain. The antenna is well suited for small cell or distributed antenna system (DAS) applications where 4G and 5G coverage is required.

The sleeve monopole antenna is fed with a strip-centered coaxial feed where the feed exits the coaxial structure and forms the Low Band (LB) main radiator. A band-stop filter is also included in the feed portion of the sleeve monopole antenna to eliminate the possibility of interference between the sleeve monopole and the patch arrays at high frequencies.

These and other objects of the disclosure, as well as many of the intended advantages thereof, will become more readily apparent when reference is made to the following description, taken in conjunction with the accompanying drawings.

### BRIEF DESCRIPTION OF THE FIGURES

FIG. 1A is a perspective view of the dual band antenna composed of a single LB radiating element along with six HB patch arrays.

FIG. 1B shows the antenna of FIG. 1A with one side of a sleeve removed.

FIG. 1C is a top view of FIG. 1A.

FIG. 1D is a perspective view of one side of the sleeve.

FIG. 1E is a side view of one side of the sleeve.

FIGS. 2A-2G illustrate detailed views of the LB main radiator, HB DCC filter, and strip-centered coaxial line along with simulation data of the DCC filter in HB frequency range.

FIGS. 3A-3C illustrate the LB simulated return loss and radiation patterns.

FIGS. 4A-4C illustrate the HB simulated return loss and radiation patterns.

FIGS. 5A-5B illustrate the performance of the LB antenna in the HB frequency range with and without the HB band stop filter integrated into the LB feed.

### DETAILED DESCRIPTION OF THE PREFERRED EMBODIMENTS

In describing a preferred embodiment of the disclosure illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several preferred embodiments of the disclosure are described for illustrative purposes; it being understood that the disclosure may be embodied in other forms not specifically shown in the drawings.

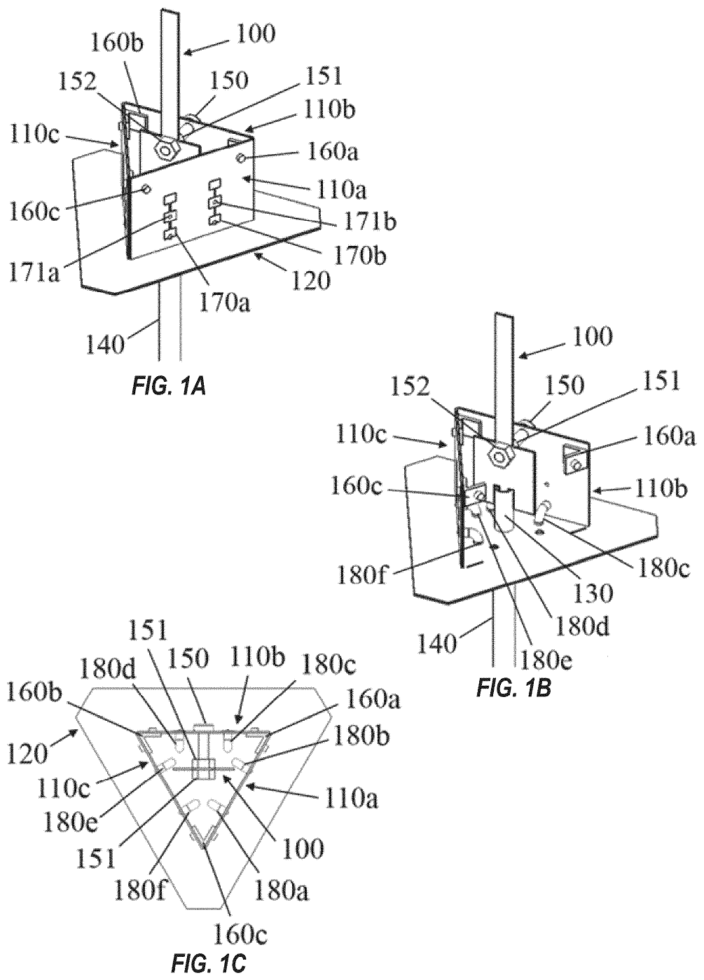

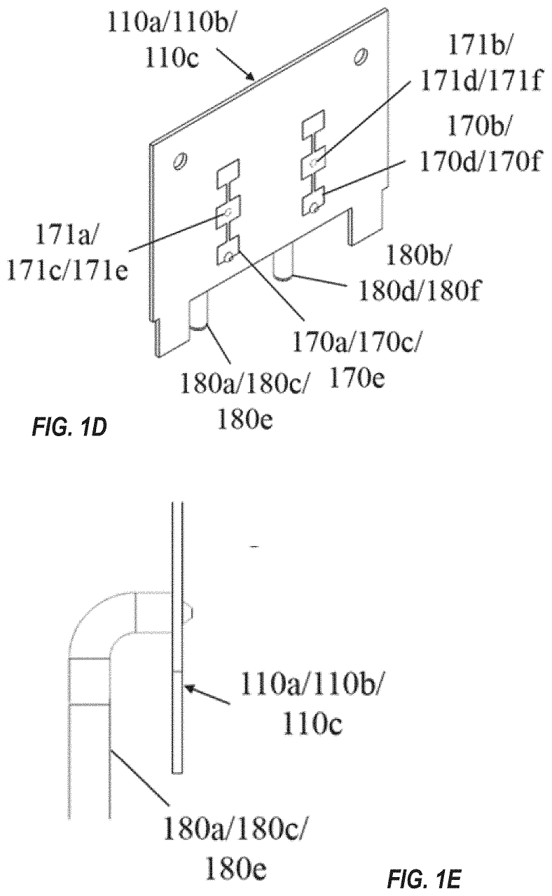

With respect to FIG. 1A, the dual band antenna assembly is shown having a low band antenna and a high band antenna. The Low Band (LB) antenna is the monopole antenna covering ˜1.7-2.7 GHz. The dual band antenna assembly can be a sleeve monopole antenna that includes a main monopole antenna or radiator 100, a sleeve antenna or sleeve 110, and a ground PCB or ground plane 120. In one non-limiting example embodiment, each of the radiator 100 and PCBs 110, 120 are composed of 0.508-mm thick Rogers RO4003 printed circuit board (PCB) material (εᵣ≈3.55, tan δ≈0.0027). The main radiator 100 is an elongated flat planar strip, shown in FIG. 1A extending substantially in a vertical direction.

The sleeve 110 has one or more sides or walls 110a, 110b, 110c that form a central opening, and have an inwardly-facing surface and an outwardly-facing surface. In the example non-limiting embodiment of FIG. 1A, the sleeve 110 has three flat planar sides formed as PCBs 110a, 110b, 110c, with an open top end and open bottom end. The three sides come together to form a cross-section having a triangular shape. However, the sleeve 110 can have any suitable size and shape, and can be a closed or open polygon, a closed or open circle, etc. The sleeve 110 surrounds at least a portion of the main radiator, and here the main radiator 100 extends into a center opening of the sleeve 110 and extends beyond the top of the sleeve 110. The radiator 100 extends through the sleeve 110 and extends down beyond the bottom of the sleeve 110, shown as feed cable 200 surrounded by an RF absorber 140. The sleeve sides 110a, 110b, 110c are each in a plane that is substantially parallel to the longitudinal axis of the main radiator 100.

The ground plane 120 is a thin planar substrate that supports the sleeve 110 and has through-holes to attach to the main radiator 100. The ground plane 120 is in a plane that is substantially orthogonal to the longitudinal axis of the main radiator 100, and has a shaped that corresponds to the shape of the sleeve 110. In the embodiment shown, the ground plane 120 is substantially triangular, and the corners can be beveled for safety. The ground plane 120 is electrically coupled to the radiator, and provides a mirrored image of the radiator because it reflects the signal from the radiator 180° out of phase.

Referring to FIG. 1B, the LB portion of the antenna is fed by a strip-centered coaxial (SCC) feed. The coaxial cable provides a closed form of transmission line to prevent extraneous coupling, though other suitable configurations can be utilized. The main radiator 100 also forms the center conductor of the SCC feed line. The SCC feed outer conductor 130 is made from metal tubing with high electrical conductivity. In one embodiment, the metal tube can be brass, but other suitable materials would also work. One factor is making sure that the tubing can be soldered. A coaxial cable is used to feed the LB portion of the antenna, and it is wrapped in RF absorber 140 for minimal impact to the radiation patterns. The LB main radiator 100 is further supported with a plastic screw 150 used to maintain the proper vertical placement, and two plastic nuts 151, 152 are used on either side of the screw to secure the LB main radiator 100 in place.

Referring to FIGS. 1A, 1D, one or more High-Band (HB) arrays 170 are mounted to each of the sleeve PCBs 110a, 110b, 110c. The HB arrays 170a, 170b also include a ground via 171a, 171b in the central element. The arrays 170 face outward on the outwardly-facing surface of the sleeve side 110, away from the main radiator 100 on the outer surface of the PCB 110. As shown in FIG. 1B, the HB arrays 170 are fed with coaxial HB feed cables 180. Referring to FIGS. 1B, 1E, the feed cables 180 extend up through respective openings in the ground PCB 120, attach to the sleeve side 110 at the inwardly-facing surface of the sleeve side 110, extend through the sleeve side 110, and connect to the HB array 170 on the outwardly-facing surface of the sleeve side 110. In the embodiment shown, there are two HB arrays aligned vertically, with the ground via therebetween. The use of two arrays allows for 2×2 MIMO on the HB.

As best shown in FIG. 1C, this configuration is consistent on all three sides of the antenna. More specifically, a first sleeve side 110a has a first feed cable 180a attached to the first HB array 170a and a second feed cable 180b attached to the second HB array 170b; a second sleeve side 110b has a third feed cable 180c attached to the first array 170a and a fourth feed cable 180d attached to the second array 170b; and the third sleeve side 110c has a fifth feed cable 180e attached to the first array 170a and a sixth feed cable 180f attached to the second array 170b.

The HB arrays 170 are fed with coaxial HB feed cables 180a, 180b, 180c, 180d, 180e, 180f where the outer conductor of the cable is soldered to the inner side of each of the three sleeve PC Bs 110a, 110b, 110c. The center conductor of each of the HB feed cables 180a, 180b, 180c, 180d, 180e, 180f is fed through a hole in the PCB and soldered to the HB patch elements 170a, 170b, 170c, 170d, 170e, 170f. A detailed view of the sleeve PCBs 110a, 110b, 110c and HB arrays 170a, 170b, 170c, 170d, 170e, 170f are shown in FIGS. 1D, 1E.

Each of the sleeves 110 are fixedly attached to the ground plane 120. In the example embodiment of FIGS. 1B, 1D, each of the sleeve PCBs 110a, 110b, 110c have a bottom edge or surface with one or more outwardly extending tabs. The tabs pass through aligned slots in the ground PCB 120, and the ground side of the tabs is soldered to the grounding on the ground PCB 120. In addition, support brackets can be provided where the sleeve sides 110 meet, to further support the sleeve structure. In the embodiment shown in FIGS. 1A-1C, a bracket 160a, 160b, 160c is provided at each corner and fastened to a top portion of the respective sleeve side 110 by a fastener such as a screw or tab on the bracket that extends through a respective opening in the sleeve side 110. The brackets 160 join the two adjacent sleeve sides 110a, 110b, 110c. Other suitable support features can be provided, and the use of tabs and/or brackets is one optional example.

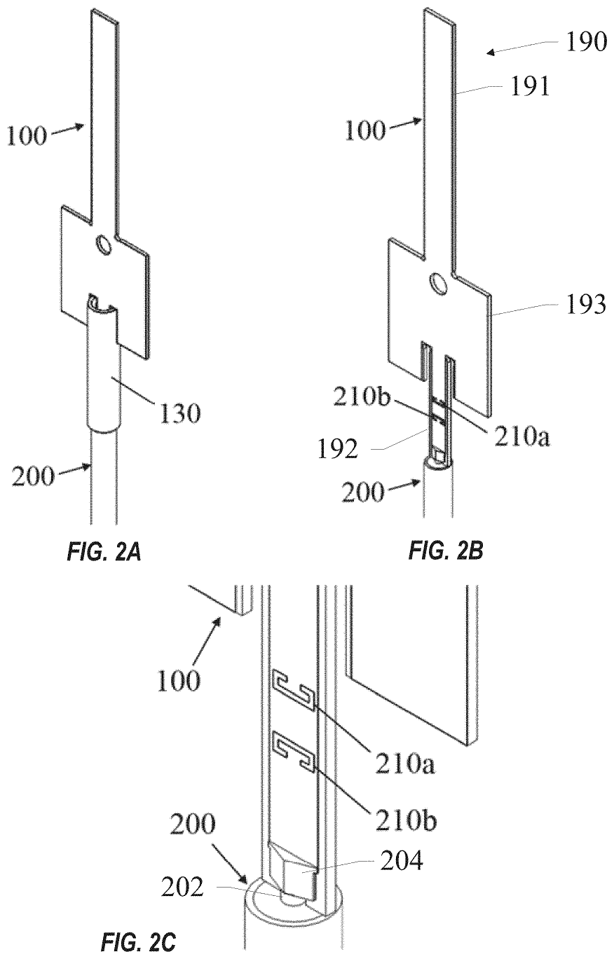

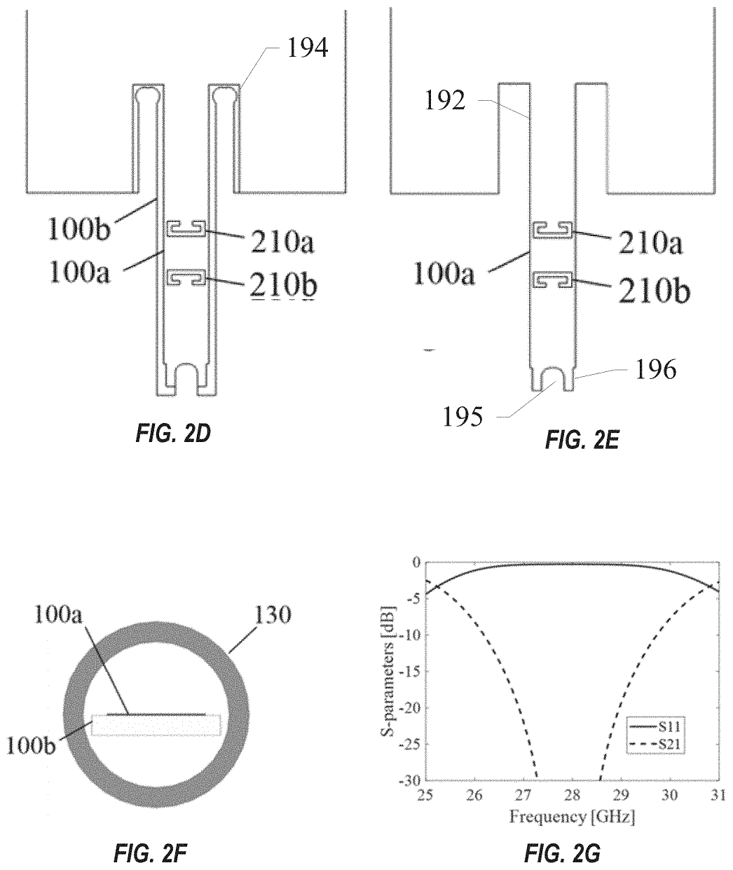

FIG. 2 shows the LB feed 190 in further detail. FIG. 2A shows the LB main radiator 100, the SCC feed outer conductor 130, and the LB feed cable 200. FIGS. 2B-2E illustrate the same components as FIG. 2A with the SCC feed outer conductor 130 removed. Here, the HB filter elements 210a, 210b are revealed, and FIGS. 2C-2E show a close-up views of the HB filter elements 210a, 210b along with a detailed view of the LB main radiator 100. The LB main radiator metallization 100a and the LB main radiator dielectric 100b are shown. The HB filter elements 210a, 210b are put in place to minimize the possibility of interference between the LB portions of the antenna (i.e., the main radiator 100 and cable 200) and the HB portions of the antenna (i.e., the arrays 170). The LB antenna element has the ability to radiate energy in the HB frequency range so spurious modes could be problematic. The filter is put in place to reflect any spurious modes that make it to the antenna so that they are not radiated and interfere with the HB operation. The HB Filter 210a, 210b can be created, for example, by voids (e.g., an intentional removal of conductor) in the conductor 100a when the LB main radiator 100 is produced using a laminate material. The LB main radiator 100 can be produce using a flat conductive sheet stock such as brass or copper which requires the HB Filters 210a, 210b to punched through the sheet stock creating a defected conductor. The void(s) or intentional defect(s) in the conductor are utilized to create the filters 210a, 210b. The voids and defects can have any shape, size or configuration to accomplish the filtering for the stop band and can be one or more to provide sufficient rejection of the required stop band.

FIG. 2F shows a cross-section of the SCC transmission line. The SCC line is the guiding structure for the DCC filter, i.e., a form of transmission line that is not coaxial. The line is composed of the SCC feed outer conductor 130, the center strip which is the LB main radiator metallization 100a, and the dielectric material which is the LB main radiator dielectric 100b. The response of the DCC filter without the antenna is shown in FIG. 2G where a deep null in S21 indicates an effective stop band over the HB frequency range. The stop band filter rejects the frequencies in the band.

As shown in the example embodiment of FIGS. 2A-2F, the LB feed 190 is a continuous element that is flat and has a thin thickness and width. The feed 190 has a distal end portion 191, a proximal end portion 192, and an intermediate portion 193 therebetween. The distal portion 191 forms the LB radiator 100, and the proximal portion 192 connects to the cable 200. Each of the distal portion 191 and the proximal portion 192 are substantially elongated, to form a general rectangular shape. The intermediate portion 193 is substantially wider than the distal and proximal end portions 191, 192, and can generally form a square shape. The size (thickness, width and/or height) and shape of the intermediate portion 193 can be adjusted to provide a suitable impedance match to the guiding structure and radiator 100 sizes and shapes of many combinations provide the same resulting match. In addition, the distal portion 191 can be slightly wider than the proximal portion 192, as desired to provide a suitable impedance. An opening is located at the top of the intermediate portion 192, which receives the screw 150, as shown in FIGS. 1A, 1B. Two channels 194 are formed in the intermediate portion 193 at the proximal end portion. The outer conductor 130 is a hollow tube that fits over the proximal end portion 192 and is received in the channels 194. The channels 194 align the position of the outer conductor 130 relative to the proximal end 192. The outer conductor 130 is conductive and produces the guiding structure discussed above.

As best shown in FIG. 2C, the cable 200 has a center conductor 202, a termination 204 such as a nut, and an outer RF absorber 140 such as an insulation layer. The termination 204 is at the distal end of the cable 200. Referring to FIGS. 2C-2E, a U-shaped notch 195 is formed at the very end of the proximal portion 192, creating two arms 196. The termination 204 is received in the notch 195 between the arms 196 to connect the proximal end 192 to the cable conductor 202. The outer conductor 130 extends over the proximal end 192 and the end of the cable 200, and also extends up through an opening in the ground PCB 120. The intermediate portion 193 of the LB feed 190 is received in the central space formed by the sleeve 110 and is fully surrounded on the sides by the sleeve 110. The intermediate portion 193 does not touch the PCB 120, but is raised above the PCB 120. The sleeve 110 provides a ground plane for the HB Elements and used to modify the elevation pattern. In one embodiment, the sleeve 110 need not fully surround the LB feed 190 or the intermediate portion 193.

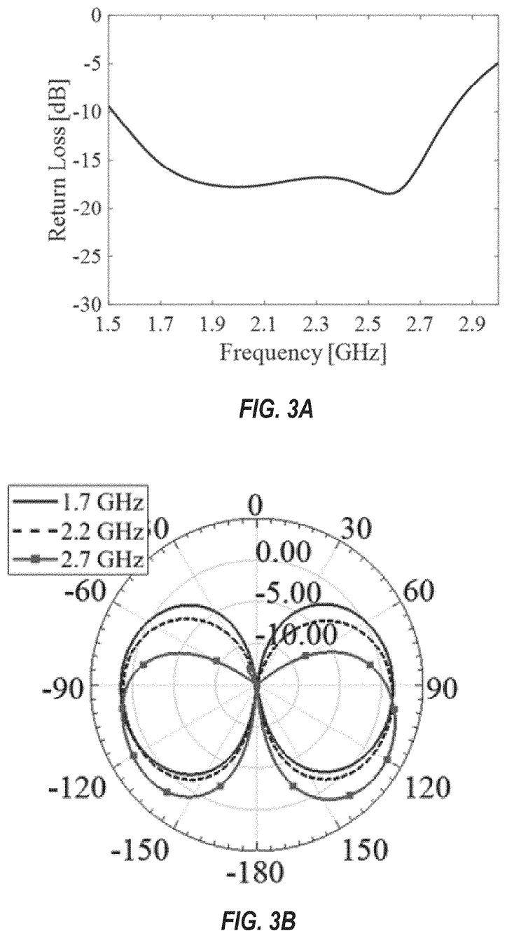

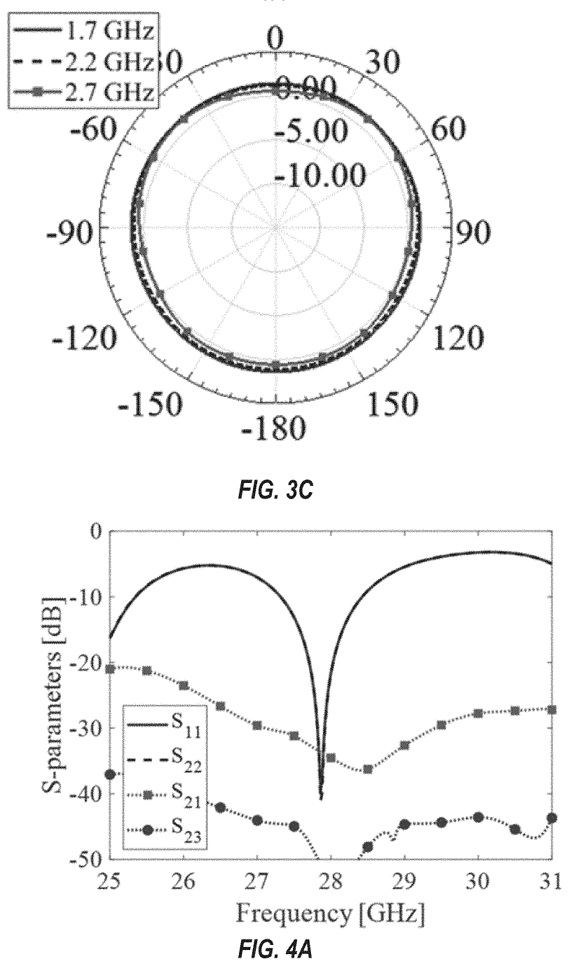

Turning to FIGS. 3A-3C, simulated return loss and radiation patterns for the LB portion of the antenna are shown, respectively. Simulations indicate a return loss better than −15 dB from 1.7-2.7 GHz, and the radiation patterns exhibit omnidirectional radiation patterns in azimuth. FIG. 3B illustrates the elevation patterns and FIG. 3C illustrates the azimuth patterns at 1.7, 2.2, and 2.7 GHz. Notice that there is downtilt that occurs in the elevation patterns over the operating range. This is a feature of the sleeve monopole antenna and could be modified with manipulation of the sleeve height.

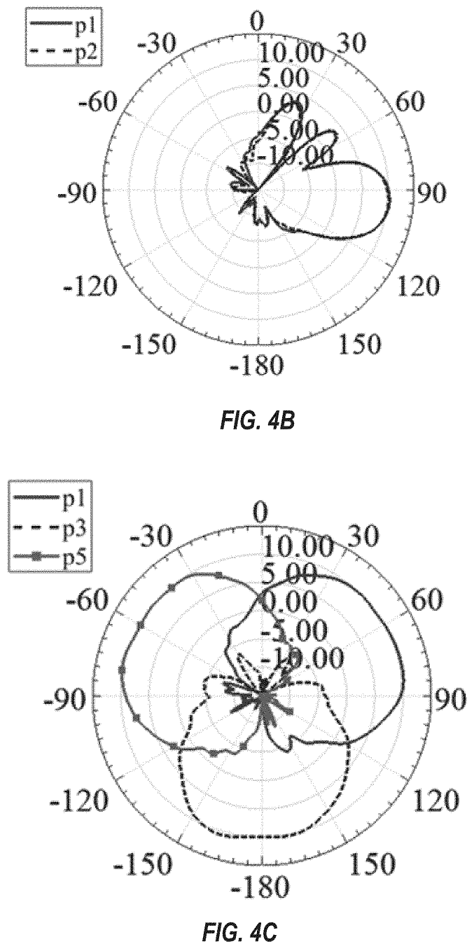

FIGS. 4A-4C show simulated return loss and radiation patterns for the HB portion of the antenna, respectively. The return loss from 27.5-28.35 is better than −10 dB, and isolation between ports used for MIMO is better than 30 dB. In this case, the isolation between the HB arrays 170a, 170b is illustrated, but isolation on all faces is similar. The isolation between ports is important for MIMO (multiple-input, multiple-output) operation where the better the isolation, the lower the energy that couples between ports and the better suited the antenna is for MIMO applications. The isolation between neighboring HB arrays 170b, 170c on different sleeve PCBs 110a, 110b is also shown to be better than 40 dB. FIG. 4B illustrates the simulated elevation patterns for HB arrays 170a, 170b, and FIG. 4C illustrates the simulated azimuth patterns for 170a, 170c, 170e. The elevation patterns illustrate a well-defined main beam pointed near horizon with a small amount of down tilt, and the azimuth patterns clearly illustrate the tri-sector radiation patterns desired by the HB arrays.

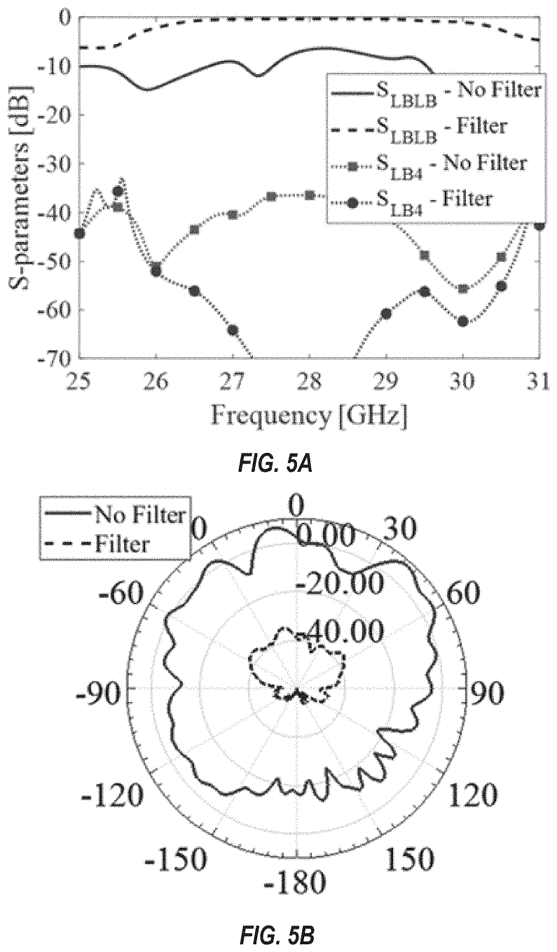

The impacts of the filter are studied in FIGS. 5A, 5B where FIG. 5A investigates the return loss for the LB portion of the antenna in the HB frequency range with and without the filter. The plot also shows the amount of coupling between the LB portion of the antenna and the HB array 170d. Without the filter, the return loss for the LB portion of the antenna in the HB frequency range is as low as −10 dB near 27.5 GHz, and the isolation between the LB portion of the antenna and the HB array 170d is around 36 dB. With the filter in place, the return loss for the LB portion of the antenna in the HB frequency range is around −0.35 dB or higher, and the coupling between the LB portion of the antenna and the HB array 170d is lower than −70 dB so the LB portion of the antenna is not able to radiate in the HB frequency range, and there is minimal coupling between the LB portion of the antenna and the HB ports. FIG. 5b illustrates the realized gain for the LB portion of the antenna at 27.9 GHz through the p=0° plane with and without the filter. The filter shows significant gain reduction for the LB portion of the antenna as desired.

It is noted that the disclosure shows the filters 210a, 210b located at the proximal portion 192 of the monopole antenna body 190. However, the filters 210a, 210b can be located elsewhere, such as at the intermediate portion 193 or distal portion 191, or at the sleeve sides 110 or on separate structural members.

It is further noted that the description and claims use several geometric or relational terms, such as linear, elongated, square, rounded, thin, beveled, parallel, orthogonal, triangular, circle, polygon, and flat. In addition, the description and claims use several directional or positioning terms and the like, such as top, bottom, inward, outward, up, down, distal, and proximal. Those terms are merely for convenience to facilitate the description based on the embodiments shown in the figures. Those terms are not intended to limit the disclosure. Thus, it should be recognized that the disclosure can be described in other ways without those geometric, relational, directional or positioning terms. In addition, the geometric or relational terms may not be exact. For instance, walls may not be exactly perpendicular or parallel to one another but still be considered to be substantially perpendicular or parallel because of, for example, roughness of surfaces, tolerances allowed in manufacturing, etc. And, other suitable geometries and relationships can be provided without departing from the spirit and scope of the disclosure.

The foregoing description and drawings should be considered as illustrative only of the principles of the disclosure. The disclosure may be configured in a variety of shapes and sizes and is not intended to be limited by the preferred embodiment. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. A wide-beam antenna assembly, comprising:
a low frequency monopole antenna; and
a sleeve having one or more high frequency antennas.

2. The antenna assembly of claim 1, wherein said sleeve forms a closed polygon.

3. The antenna assembly of claim 2, wherein one or more sides of the polygon include one or more sleeve antenna elements or arrays operating at a sleeve frequency range higher than a frequency range of said monopole antenna.

4. The antenna assembly of claim 3, wherein two or more of the sleeve antenna elements or arrays are configured for MIMO operation.

5. The antenna assembly of claim 1, wherein said monopole antenna includes a filter to block potential interference in an operating range of the high frequency antennas.

6. The antenna assembly of claim 1, said sleeve having a central opening, wherein the monopole antenna extends at least partially though the central opening of said sleeve.

7. The antenna assembly of claim 1, wherein said sleeve forms an open polygon.

8. The antenna assembly of claim 1, said monopole antenna having a proximal portion, further comprising an outer conductor surrounding at least the proximal portion of said monopole antenna.

9. The antenna assembly of claim 1, wherein said sleeve comprises one or more walls surrounding at least a portion of said monopole antenna.

10. The antenna assembly of claim 1, wherein said one or more high frequency antennas comprise an array mounted to said one or more walls.

11. The antenna assembly of claim 10, wherein said one or more walls form a closed surrounding.

12. The antenna assembly of claim 10, wherein said one or more walls form an open surrounding.

13. The antenna assembly of claim 1, further comprising a ground plane

14. The antenna assembly of claim 13, wherein said sleeve is mounted to said ground plane and said monopole antenna extends through said ground plane.

15. The antenna assembly of claim 13, wherein said ground plane is in a plane that is substantially orthogonal to a longitudinal axis of said monopole antenna.

16. The antenna assembly of claim 1, wherein said monopole antenna is coupled to a cable.

17. A defected center conductor coaxial filter, comprising:
an outer conductor; and
a center conductor comprising a strip that contains voids or inclusions that provide filtering.

18. The filter of claim 17, where the voids or inclusions create a stop band that blocks signals in a specified frequency band.

19. The filter of claim 17, where the voids or inclusions create a passband that passes signals in a specified frequency band.

20. The filter of claim 17, further comprising a sleeve monopole antenna, said center conductor coaxial filter coupled to said sleeve monopole antenna.
